(19) United States
(12) Patent Application Publication
(10) Pub. No.: US 2005/0203882 A1
(43) Pub. Date: Sep. 15, 2005

(54) Internet historical screen presentation

(75) Inventor: Hector Stuart Godley, Hsinchu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co.

(21) Appl. No.: 10/798,177

(22) Filed: Mar. 11, 2004

(51) Int. Cl. G06F 17/30

(52) U.S. Cl. 707/3; 707/7

(57) ABSTRACT

A method and system of capturing Internet Web screens, while using a standard browser, is provided. Using a browser plugin, the history recorded by the browser itself is used to create a presentation. It permits a user to modify the order and content of the screens captured and to create a tailored presentation. All hyperlinks are preserved and the URL is added to each screen to enable the user to return to the Web page at any time. Presentations can be saved for archival purposes to document information gathered on the Internet, and can be shared over a network.

### BACKGROUND OF THE INVENTION

1. Field of Invention

This invention relates generally to having the ability to save Internet browser sessions and, more particularly to an enhanced method that builds a history of the session that allows extensive control in sorting and editing of the saved screens with the ability to save and make presentations.

2. Description of Related Art

Use of the Internet in business the past few years has evolved from a casual use where the user utilizes his Internet browser to search for information, and upon finding it writes it down or prints it out for later reference. This works fine for getting information that is temporary and has no critical impact to the running of the business. A phone number of a supplier or customer can be easily copied to existing systems and there is no reason to save the Internet session that collected the data.

As the impact of the Internet has grown, so has the need to have tools that can use such information in presentations and reports. More and more references point to the Internet, and Internet presentations or demonstrations are available which have significant business use.

Reuse of the reference information has become vital. Also, if a company starts to develop processing and procedures based on this information, it typically wants to have the source available for later retrieval for at least historical purposes. As Internet sites can and are changed constantly, having the information saved and recorded as it initially existed is important to users.

Methods to record Internet browser screen shots are available today. At a minimum they record the raw information, both text and graphic, in the original Hypertext Markup Language (HTML). They are similar in function to creating a carbon copy. While this capability is better than not being able to record the Internet session at all, using the information later can be difficult. This is because such Internet “screen shots” contain a significant amount of advertisements and other unrelated and sometime confusing information that has nothing to do with the information desired to be saved. Returning to these screen shots several months or years later may be confusing to a user and retrieval of the actual required information could be difficult, if not impossible. Additionally, hyperlinks (i.e., references to locations of other material on the Internet) contained within the screen shots may have long since been changed.

The method of this invention solves these problems. It provides a recorded history plus it incorporates the tools to convert the Internet Web screens into slides (screen shots) that can be edited into convenient reusable information. It extends the capability of the Internet browser. It allows the user to view a plurality of past histories and change content and screen shot order directly within the browser. This can be saved in many different useful formats for placing into business documents in order to record a history of the collected information, or to create a presentation.

There are several known methods for providing some history capability. One provides a data processing system and method for Internet browser history generation. Another provides a global history view that creates a single page icon of each screen shot. There is an apparatus and method for loading and reloading HTML pages having cacheable non-cacheable portions. There is also a method for monitoring user interaction with Web pages from Web servers using data and command lists for maintaining information visited and issued by users.

### SUMMARY OF THE INVENTION

This invention's overall objective is to provide a method and system for the capturing of Internet Web screens. This objective includes providing a plugin to standard browsers that has a Graphical User Interface (GUI) for executing function and viewing the results. It is an objective to use the standard browser's history of Universal Recourse Locator (URL) addresses as the source to the browser plugin. One objective of the browser plugin program is to create screen shots of each screen from the browsers history, and then be able to save these screen shots in any order to create a presentation to be saved in one of many presentation program formats. Another objective is to enable a user to search for and view information contained within the saved Web pages and to quickly find information collected. Also, it is an objective to have the plugin program provide function for the editing of the data contained in the screen shots. This includes both text and graphics, and has the ability to save the screen shots in formats within a screen shot file that can be used to display presentation slide shows. Additionally, it is an objective to have all hyperlinks that were contained in the original Web screens saved so that they can still be used. Lastly, it is an object to create a new hyperlink and place it on the screen shot that containing a link back to the from screen that originally call the Web page. This allows the user to change the sequence of the screen shot in a presentation and always know how to return to the calling Web page.

### BRIEF DESCRIPTION OF THE DRAWINGS

This invention will be described with reference to the accompanying drawings, wherein:

FIG. 1 is a diagram of an Internet browser screen shot showing a prior art method.

FIG. 2 is a diagram showing an example history file.

FIG. 3 is a block diagram showing the system structure and flow of data of the plugin.

FIG. 4 is a visual illustration of the plugin window and showing the “Find Site” pull down functions.

FIG. 5 is a block diagram showing the thumbnail view of the captured Web page (screen shot) images.

FIG. 6 is a visual illustration of the plugin window specifically showing the “Presentation” pull down functions.

FIG. 7 is a visual illustration of the plugin window specifically showing the “File” pull down functions.

### DETAILED DESCRIPTION OF THE PREFERRED EMBODIMENT

As the use of the Internet has become commonplace, its usefulness as a key information source is now part of most business processes. One example is checking or making an airline flight reservation. Many consumer and business purchases are made over the Internet. For individual consumers, as well as business users, this is a fast and practical way to get information and products.

However, there is a problem that all users face while using the Internet, the saving of information collected for later verification. For an airline ticket purchase this can be resolved by simply printing out on a Personal Computer (PC) printer the receipt presented by the airline at the end of the purchase. This requires, of course, an attached printer and takes some time. The decision making information contained in each screen shot prior to the actual purchase is lost, however, unless the user printed each of the screens as well. It gets even more complicated to save this information when one is gathering important information that a business will use to eventually make decisions. Most of the screens contain parts of the information and not the whole. The screens may also be connected by numerous hyperlinks, many of which must be followed to get the all the needed information. Hyperlinks, while being powerful, can make the collected data non-sequential and hard for someone else to later follow.

Of course, a person who later follows the information trail of screen shots is dependent on the original person that did the browsing to have taken the time to save a history of the browsing, which is typically not done due to the time required. All data associated with the Internet session is lost upon exit from the session, unless saved to a printer or to a file.

The simplest way of saving information during an Internet browser session is by using the history function that is integrated into most browsers. FIG. 1 shows where one finds this function while looking at a browser screen 10, and clicking on the function History. This function may be located in a different place on each browser type, but is typically provided in some form by all browser programs. Choosing the function produces a pull down window 12 that contains a sequential list of the Universal Resources Locator (URL) addresses of the web sites visited during the current browser session. However, while most browsers have a temporary capability of saving this history once the session has ended, none keeps a permanent record. Also, this is only a record of the URL's and not the screens themselves. Thus, the data at any particular web site page may be changed the next time the address is accessed.

This lack of a permanent record of the data collection and the ability to save it in a useful way for later use is a significant problem. For a casual user, printing out the information and saving it in a file is probably a cost effective way around the problem. For business where retrieval of the source information can be critical for day to day operations, an improved method is required. The method and system of this invention provides a solution that solves both the data saving and retrieval problems. It does it in a way that allows for the easy reorganization of the information into a format that a user looking at the information at a later date can better understand. It also provides the capability to share this information immediately by helping the user turn it into a presentation slide show, for example.

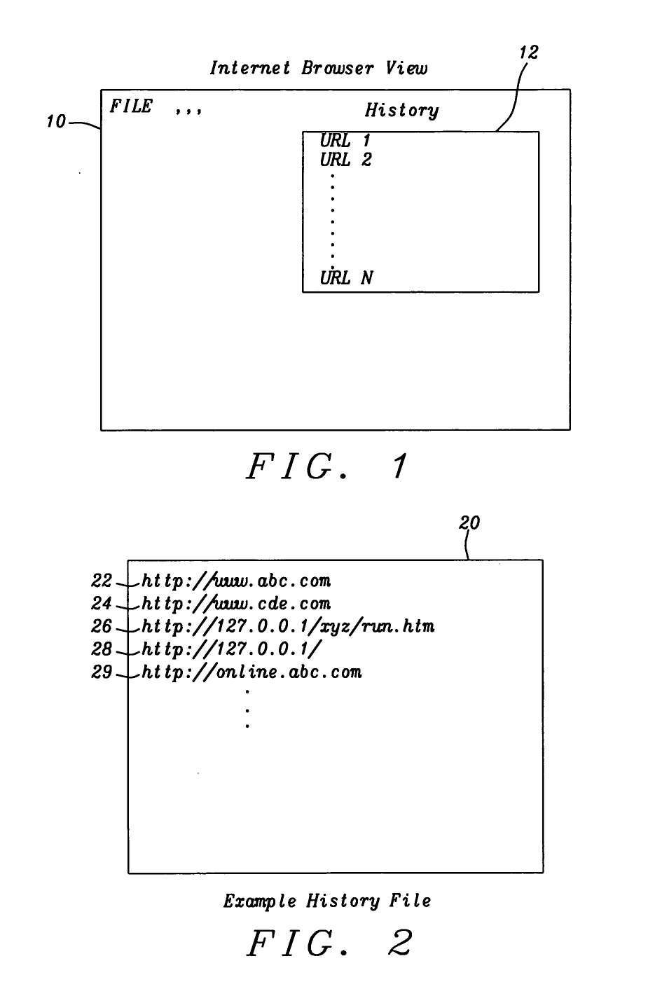

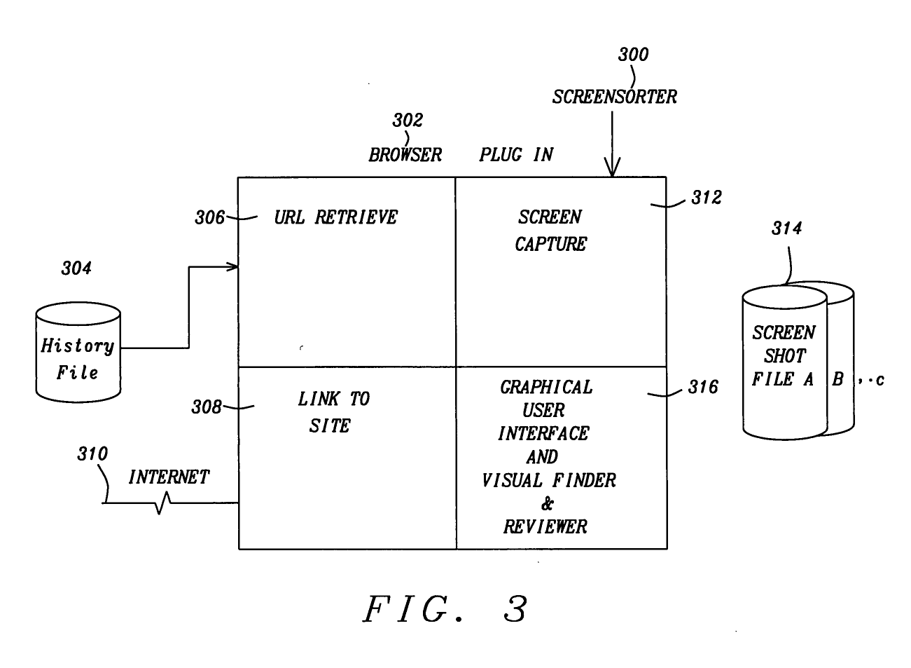

When using the Internet World Wide Web (WWW), browsers will record a history of each URL destination. This history is recorded in a file (data set) and the URL's are saved in the order that the user displayed them. Microsoft's Internet Explorer (IE) saves this URL information with the Windows registry. Other browsers save the information in a similar manner, but in a data set usually in their own installation folders. No matter where the history is saved the method of the invention works the same. It is independent of the browser used as long as the browser saves a history in a text readable format. FIG. 2 shows an example of a saved history file window display 20. Within the history file is a sequential list of the exact URL's visited. Usually the most recently visited is on top so that http://www.abc.com 22 would be the site last seen by the user. The site of the screen visited just before that was http://www.cde.com, 24 with http://127.0.0.1/xyz.run.htm 26 being a Web page seen previously. Prior addresses include http://127.0.0.1/ 28 and http://online.abc.com 29 respectively.

The key to the new method and system is the creation of a browser plugin. This is a program that adds additional function to the browser, and all browsers commonly in use today allow for plugins to be created and added to them. Users simply download the plugin and follow the steps given on a Web page, for instance, to install it. They then have all the function of the plugin ready to use which is then accessible anytime while using the browser.

One implementation of the invention has been written for Microsoft's Internet Explorer (IE) although with common coding changes, it is possible to write a plugin with the same functions to be described for the plurality of browsers available today. The plugin's function is accessed from the browser window. Once it is added to the browser, a command called “Screensortor” is added to the view menu of the browser for the user to click on when it is desired to work with the Web screens in the save history file.

The plugin is written containing four main functions. FIG. 3 is a block diagram that shows the structure and data flow of the Browser Plugin 302 once the “Screensortor” 300 command is clicked on within the browser. The first function is the URL Retrieve 306 function. This function opens the history file 304 (in the case of the IE browser it reads directly from the Windows registry file). For example, this function is written in the C++ language, but any appropriate language would work as is true of any of the mention languages noted below. It sends a message to the user as it opens the URL data of “Collecting Data—Please Wait”. This wait is because the URL Retrieve function is passing to the Link to Site function 308 (written in Microsoft's Visual Basic language) that actually does a connection through the Internet 310 to each URL address in the history file. The Link to Site function passes each site page to the Screen Capture 312 function that uses Java language capabilities to create a screen shot of each site saved in a Screen Shot file or folder 314 where the user can give the screen shot a unique file name such as the File A, B, and N shown in FIG. 3.

Once all the screen shots of the URL's are captured and stored, they are accessed by a separate option function within the plugin called “Internet Slide Sorter” that provides the function to present each screen shot visually in a Graphic User Interface (GUI) and provides a Visual Finder and Reviewer 316. This program is written in C++ again using Visual Basic and Java as required, and is launched directly from within the plugin by clicking on an Option tab at the top of the plugin window. A prompt from a drop down menu is presented that allows the user to search for sites or save presentations. At this point the Screen Shot File contains a complete graphical image of each Web screen URL. Also preserved are the hyperlinks that each page contained. Thus, the screen shot works just like it originally did where clicking on the hyperlink will take the user to it's coded address. This folder is essentially a slide history of the most recent screens that were visited. The “Internet Visual Finder and Reviewer” function will then allow the user to view (such as the slide sorter tool used in Microsoft's PowerPoint) the most recent pages visited. The programs view options allow the user to view as a series of slides or exploded screen shots. Furthermore, to each screen shot is added a hyperlink to the page that it came from. From the slide screen sorter, the user can double click to view an exploded screen shot. A further double click will take the user back to the web site that it originally came from.

Pages that are security controlled can not be revisited this way, but the screen shot enables the user to remember what he saw. In the slide view, the user can move (change the order), or duplicate or delete any of the pages to generate a presentation of up to, for example 40 pages. (This is a current limit that could be easily increased although performance would suffer because of the size of the file). This combination can then be saved and previewed on the browser. It can then be saved onto the PC as a stand-alone HTML file, or word processor or presentation file such as MS-Office (Powerpoint, Word) presentation, or it can be entered into an existing presentation file. Importantly, all slides have their calling hyperlink saved, embedded as a button at the bottom of each screen. This enables the opportunity for the presenter to hyperlink back to that specific from page for further details of that page and permits reordering of screens for a presentation while still obtaining the ability to get back to the page that call it.

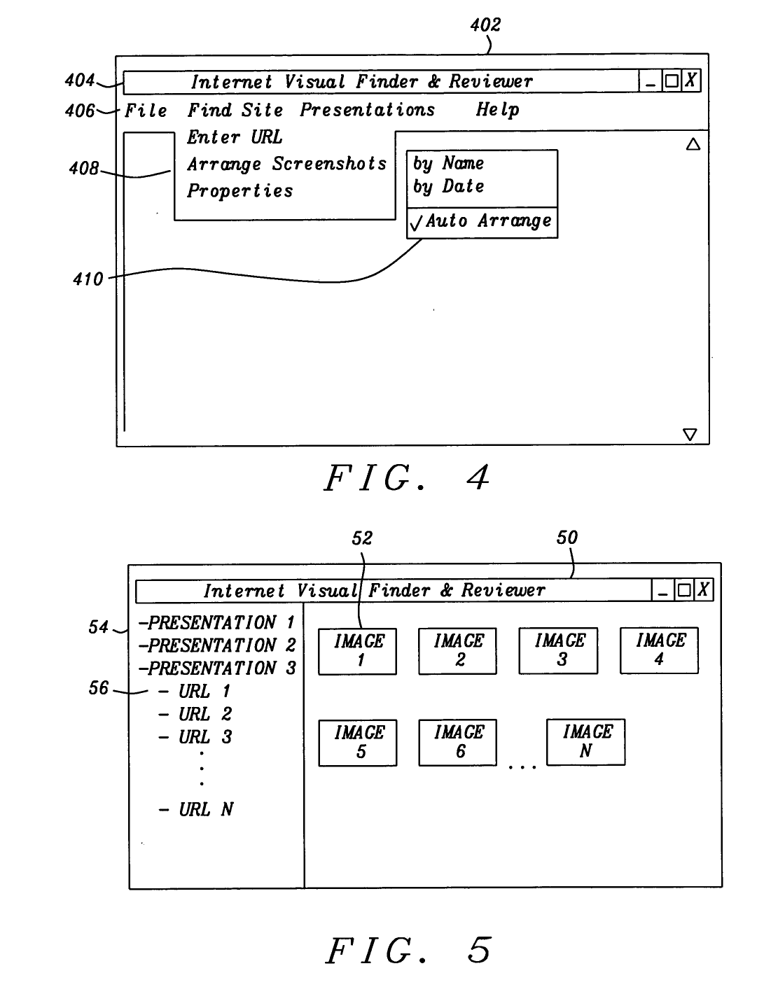

FIG. 4 shows a visual illustration of what the plugin screen 402 looks like. The Internet slide Sorter—Internet Visual Finder & Reviewer” is the title of the function 404. Drop down functions are available under File, Find Site, Presentation and Help 406. The example shown in FIG. 4 is for the user clicking on Find Site. A user would do this if he wanted to locate the screen shot of a site that was previously visited and saved. In the pull down window under Find Site 408 are the options “Enter URL”, “Arrange Screenshots”, and “Properties”. “Enter URL” offers users an easy way to find recently visited sites by entering the URL via a pop-up window 410 that offers the options “by name” and “by date” as additional options to help in the searching of the site screen shot. However, if a user cannot recall the URL name, he can go to the screen shot viewer “Arrange Screenshots” option and auto-arrange them by alphabetical name, date or by the default order before viewing them. The “Properties” option provides details of the screen capture and image name.

Clicking in the “Arrange Screenshot” option opens a window that creates thumbnail graphics of each captured image. This is an overall view of all the Web pages visited. FIG. 5 illustrates an opened window. Image 1 52 is the first image in the sorted order. Images 2 to N are additional images in the session. Each screen shot image shown in this window is designed to show a larger user readable image as the mouse rolls over it. A frame in the window to the left 54 shows which presentation file the images are in, and it lists the actual URL's of each image. A double click on the image causes the browser to immediately go to that Web site while still keeping this plugin window open.

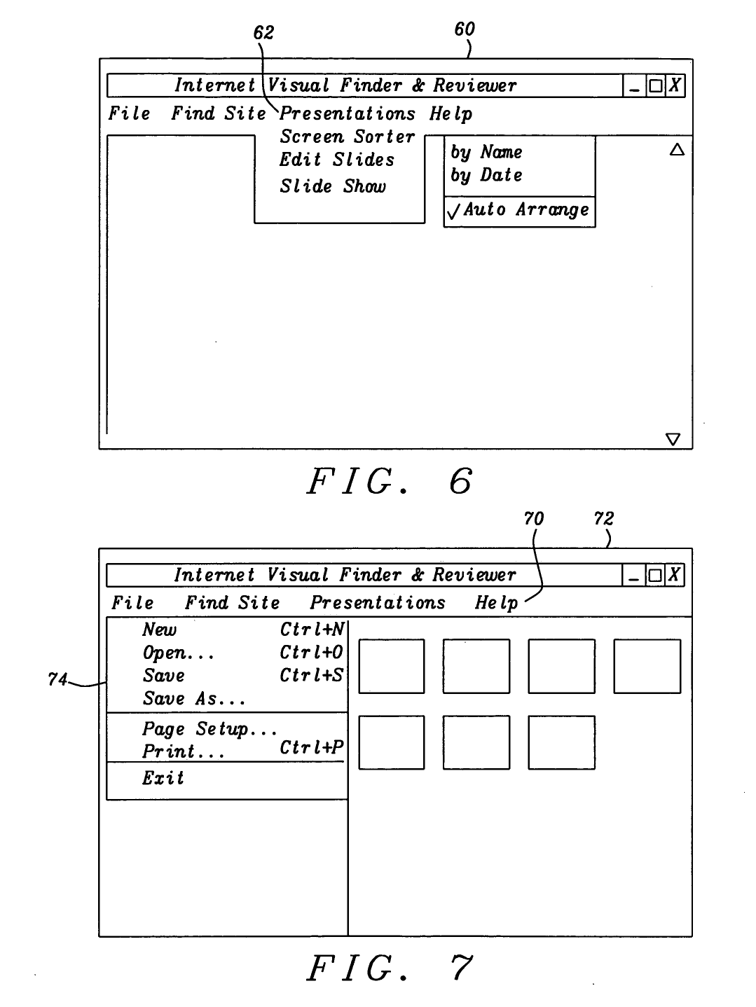

FIG. 6 shows the window view 60 of the “Presentations” pull down function 62. The “Screen Sorter” option enables users to view the captured screens as small images as before within the presentations file. They can be sorted alphabetically or by date. Screen shots can be moved, copied, deleted or rearranged by simply highlighting the thumbnail image or using drag and drop techniques. This allows the user to create a presentation of the screen shots in any order and with any screen content. With the “Edit Slides” option, double clicking on the displayed thumbnails places the screen image into an edit mode filling the frame with that image. Each screen shot can then be edited with text entries and additional image insertions with full editing capabilities. With the “Slide Show” option the user is able to view all the current images in the file as a full screen presentation much like in Microsoft's Powerpoint.

The last two functions of the Plugin are “File” and “Help”. The “Help” function, shown in FIG. 7 70, operates just like all common Windows help functions. The plugin view 72 of the “File” function pull down view 74 is showed in FIG. 7. The options are similar to all Windows based programs. The “New” option allows the user to create a new presentation file that screen shots can be placed into and all the previously described functions can operate on it. The “Open” option allows the user to point to and open a previously created presentation file to view or modify further. The “Save” option saves the currently opened presentation content in its current state. The “Save As” option is the same the “Save” option, but allows creating a new file with a new name preserving the original file without modifying it. One key function of the “Save” and “Save As” options is that there is an additional option provided to save the presentation in one of many existing PC presentation formats, such as HTML or Microsoft's Powerpoint, and Word word processing. The “Page Setup” option allows controlling the basic Windows printer options in a normal Windows fashion. The “Print” option allows the user to print out the presentation or individual screen shots. The “Exit” option ends the operation of the plugin.

One important use of the presentation files, other than for use in a presentation, is to provide an archival history of the plurality of the information obtained off the Internet. As important information in running a business is now commonly found on the Internet, this system and method creates a simple archive for later retrieving the source of the information. The search function helps find old data. If it is desired that a paper copy is to be stored and filed, printing of the screens is easily done with the benefit of important information highlighted and the deletion of extraneous information looked at during the Web session already eliminated before printing. The presentation files can be sent to a common location on the network to be shared or archived and stored as business or other requirements provide.

The method of the invention provides advantages over the prior art including being a simple browser plugin that saves Web screens using the browsers own history file function. Screen images are captured into presentation file that can be edited or deleted. All hyperlinks are preserved and a hyperlink is added to each page at the bottom to allow a user to go back to the screen from where it came from no matter what order the screen are finally placed. Screen shots can be easily found, and screen shot files can be saved and shared with presentations methods being available for immediate presentations.

While the invention has been particularly shown and described with reference to preferred embodiments thereof, it will be understood by those skilled in the art that various changes in form and details may be made without departing from the spirit and scope of the invention.

1. A method of capturing Internet Web screens, comprising:
a. providing a browser plugin program with a graphical user interface;
b. using a standard browsers history of universal resource locator addresses as source of the browser plugin program;
c. creating screen shots from the standard browsers history of the most recently viewed Internet Web screens;
d. enabling searching and viewing of the screen shots within a screen shot file, and
e. providing function for the editing of said screen shots into common formats that can produce presentations.

2. The method of capturing Internet Web screens of claim 1, wherein said browser plugin program can be written for any standard browsers.

3. The method of capturing Internet Web screens of claim 2, wherein said browser plugin program creates a graphical user interface window from which all functions are executed.

4. The method of capturing Internet Web screens of claim 3, wherein said plugin program creates a screen shot of each said universal resource locator addresses using said graphical user interface to present to a user.

5. The method of capturing Internet Web screens of claim 4, wherein said plugin program provides function to search for saved said universal resource locator address and text contained within said screen shots.

6. The method of capturing Internet Web screens of claim 5, wherein said plugin program provides function to relocate said screen shots into a difference sequence for developing a presentation.

7. The method of capturing Internet Web screens of claim 6, wherein function is provided to edit text withing each said screen shot.

8. The method of capturing Internet Web screens of claim 7, wherein function is provided to edit all graphics within each said screen shot.

9. The method of capturing Internet Web screens of claim 1, wherein hyperlinks are preserved in each said screen shot to allow them to work as originally created.

10. The method of capturing Internet Web screens of claim 1, wherein a new hyperlink is created and placed at the bottom of each said screen shot to enable a user to click on it and be able to return to a calling screen.

11. The method of capturing Internet Web screens of claim 1, wherein said screen shots can be edited and placed into separate files for development of a presentation.

12. The method of capturing Internet Web screens of claim 11, wherein said files can be saved and provide an archive of an Internet Web session.

13. The method of capturing Internet Web screens of claim 11, wherein said presentation can be shown as a set of slides by using a slide show function provided in said plugin program.

14. The method of capturing Internet Web screens of claim 1, wherein said screen shot file can be saved and shared on a network for common access to said screen shots.

15. The method of capturing Internet Web screens of claim 1, wherein hyperlinks contained in said screen shots are saved.

16. The method of capturing Internet Web screens of claim 1, wherein a new hyperlink to link back to said Internet Web screen that it was called from is created.

17. A system of capturing Internet Web screens, comprising of:
a. a means to provide a browser plugin program with a graphical user interface;
b. a means to use a standard browsers history of universal resource locator addresses as source of the browser plugin program;
c. a means to create a screen shots from the standard browsers history of the most recently viewed Internet Web screens;
d. a means to enable searching and viewing of the screen shots within a screen shot file;
e. a means to provide function for the editing of said screen shots into common formats that can produce presentations.

18. The system of capturing Internet Web screens of claim 17, wherein said browser plugin program can be written for any standard browsers.

19. The system of capturing Internet Web screens of claim 18, wherein said browser plugin program creates a graphical user interface window from which all function are executed.

20. The system of capturing Internet Web screens of claim 19, wherein said plugin program creates a screen shot of each said universal resource locator addresses using said graphical user interface to present to a user.

21. The system of capturing Internet Web screens of claim 20, wherein said plugin program provides function to search for saved said universal resource locator address and text contained within said screen shots.

22. The system of capturing Internet Web screens of claim 21, wherein said plugin program provides function to relocate said screen shots into a difference sequence for developing a presentation.

23. The system of capturing Internet Web screens of claim 22, wherein function is provided to edit text withing each said screen shot.

24. The system of capturing Internet Web screens of claim 23, wherein function is provided to edit all graphics within each said screen shot.

25. The system of capturing Internet Web screens of claim 17, wherein hyperlinks are preserved in each said screen shot to allow them to work as originally created.

26. The system of capturing Internet Web screens of claim 17, wherein a new hyperlink is created and placed at the bottom of each said screen shot to enable the user to click on it and be able to return to the calling screen.

27. The system of capturing Internet Web screens of claim 17, wherein said screen shots can be edited and placed into separate files for development of a presentation.

28. The system of capturing Internet Web screens of claim 27, wherein said files can be saved and provide an archive of an Internet Web session.

29. The system of capturing Internet Web screens of claim 27, wherein said presentation can be shown as a set of slides by using a slide show function provided in said plugin program.

30. The system of capturing Internet Web screens of claim 17, wherein said screen shot file can be saved and shared on a network for common access to said screen shots.

31. The system of capturing Internet Web screens of claim 17, wherein a means where hyperlinks contained in said screen shots are saved.

32. The system of capturing Internet Web screens of claim 17, wherein a means where a new hyperlink to link back to said Internet Web screen that it was called from is created.
